(19) United States
(12) Patent Application Publication
(10) Pub. No.: US 2002/0136197 A1
(43) Pub. Date: Sep. 26, 2002

(54) Enhanced frame structure for use in advanced television systems committee standards broadcast

(75) Inventors: Henry Owen, Medford, NJ (US); Zygmond Turski, Florence, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/092,779

(22) Filed: Feb. 11, 2002

Related U.S. Application Data
(60) Provisional application No. 60/267,957, filed on Feb. 9, 2001.
(60) Provisional application No. 60/280,961, filed on Apr. 2, 2001.

(51) Int. Cl. H04J 3/06

(52) U.S. Cl. 370/350; 370/503

(57) ABSTRACT

An enhanced frame structure for a system for transmitting and receiving digital television signals as a plurality of frames and method of using same. The enhanced frame structure contains an initial frame structure containing at least two fields, each of said fields having a field synchronization segment followed by a plurality of initial frame structure data segments and a first or more modified frame structures containing at least two fields. Each of said fields has a field synchronization segment followed by at least a plurality of first modified frame structure data segments that is less than the plurality of initial frame structure data segments. The method includes the steps of conducting a site survey of the area to receive said signals, selecting an appropriate training sequence signal mode of the enhanced frame structure selected from the group consisting of a mode for an initial frame structure and a mode for a first or more modified frame structure, programming a system for broadcasting said signals with said selected training sequence signal mode, operating said system to broadcast said signals, conducting a field test and adjusting the training sequence signal mode according to the results of the field test.

### CROSS-REFERENCE TO RELATED APPLICATIONS

This application claims the benefit of U.S. Provisional Application No. 60/267,957, filed Feb. 9, 2001 and No. 60/280,961, filed Apr. 2, 2001, both of which are herein incorporated by reference.

### BACKGROUND OF THE INVENTION

In an effort to standardize broadcast parameters for Digital Television (DTV), the FCC has adopted the Advanced Television Systems Committee (ATSC) Standard for Digital Television (DTV). The standard comprises an eight vestigial sideband (8-VSB) modulation scheme and has been under extensive field testing. The current ATSC digital television standard includes provision for a single frame structure for terrestrial broadcast. FIG. 1 illustrates the frame structure for the current standard. It shows the organization of a frame of data, and is read from left to right in each row, and from top to bottom between rows. Each row represents one segment of data. The frame begins with a field synchronization sequence (first row) that lasts for 77 uS. The field synchronization sequence is followed by 312 segments of 77 uS each to make up one data field. Two data fields combine to form a data frame. The beginning of each segment starts with a four symbol segment synchronization sequence.

Broadcast tests conducted so far reveal substantially inadequate performance when receiving signals in a heavy dynamic multipath environment. Multipath phenomena are caused by the reflection of a transmitted signal from one or more surfaces, so that a receiver observes not only the original signal, but also one or more reflections. Numerous published reports point out to the inferior characteristic of the ATSC standard. For example, only one training sequence, contained in the field synchronization sequence, is available every 24 mS. This training sequence provides the information necessary to train an equalization filter (a component in a DTV receiver) so that multipath effects are removed from the received data. If the dynamic nature of the multipath environment is such that it changes rapidly with respect to the 24 mS field interval, the equalization filter will not adequately perform its function. For example, if the reflecting surfaces are moving (i.e., swaying trees or buildings, moving vehicles and the like), the multipath phenomena become too dynamic for current scheme and the equalization filters to compensate. That is, the desired convergence between the data field and the training function will be maintained for only a certain data field duration and will diverge thereafter.

Furthermore, comparisons have been drawn to the currently deployed European standard based on a coded orthogonal frequency division multiplexing (COFDM) modulation scheme, claiming the latter's superior performance. Suggestions to change the current ATSC modulation scheme from 8-VSB to COFDM are voiced frequently. Nonetheless, there is also and urgent need in the art for an improved frame structure in the ATSC DTV standard to reduce image distortion in a signal received in a dynamic multipath reception environment.

### SUMMARY OF THE INVENTION

The disadvantages of the prior art are overcome by the invention of an enhanced frame structure for transmitting and receiving wireless transmissions (i.e., digital television signals or mobile data signals) as a plurality of frames. The enhanced frame structure contains an initial frame structure containing at least two fields, each of said fields having a field synchronization segment followed by a plurality of initial frame structure data segments and a first or more modified frame structures containing at least two fields. Each of said fields has a field synchronization segment followed by at least a plurality of first modified frame structure data segments that is less than the plurality of initial frame structure data segments. The enhanced frame structure further comprises second, third, fourth and fifth modified frame structures similarly containing at least two fields. Each of said fields has a field synchronization segment followed by a plurality of respective modified frame structure data segments that is less than the plurality of the modified frame structure data segments of the preceding modified frame structure.

A method for utilizing the enhanced frame structure for the transmission of wireless data signals (i.e., broadcast of digital television signals) is also disclosed. This method includes the steps of conducting a site survey of the area to receive said signals, selecting an appropriate training sequence signal mode of the enhanced frame structure selected from the group consisting of a mode for an initial frame structure and a mode for a first or more modified frame structure, programming a system for broadcasting said signals with said selected training sequence signal mode, operating said system to broadcast said signals, conducting a field test and adjusting the training sequence signal mode according to the results of the field test.

### BRIEF DESCRIPTION OF THE FIGURES

The teachings of the present invention can be readily understood by considering the following detailed description in conjunction with the accompanying drawings, in which:

FIG. 1 depicts a typical frame structure for the current ATSC broadcast standard;

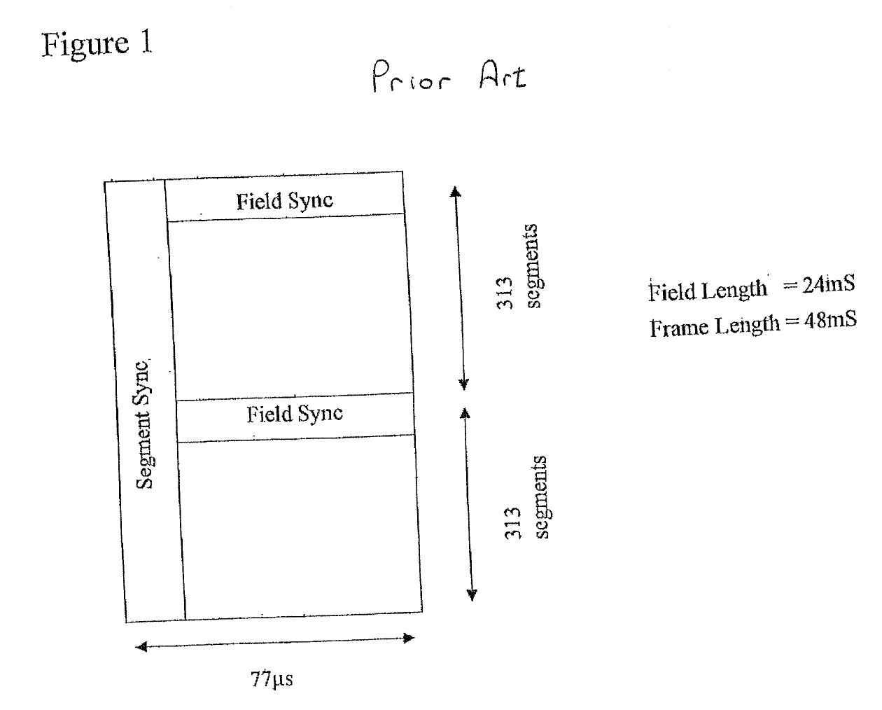

FIG. 2 depicts a detailed view of one of the fields of the frame in an expanded format;

FIG. 3A depicts the standard frame structure as a first mode of operation in accordance with the subject invention;

FIG. 3B depicts a second frame structure as a second mode of operation in accordance with the subject invention,

FIG. 3C depicts a third frame structure as a third mode of operation in accordance with the subject invention;

FIG. 3D depicts a fourth frame structure as a fourth mode of operation in accordance with the subject invention;

FIG. 3E depicts a fifth frame structure as a fifth mode of operation in accordance with the subject invention;

FIG. 3F depicts a sixth frame structure as a sixth mode of operation in accordance with the subject invention;

FIG. 4 depicts a series of method steps for practicing a first embodiment of the subject invention; and

FIG. 5 depicts a series of method steps for practicing a second embodiment of the invention.

To facilitate understanding, identical reference numerals have used, where possible, to designate identical elements that are common to the figures.

### DETAILED DESCRIPTION

The subject invention discloses a modified frame structure for the transmission of data in wireless information/communication systems. An exemplary broadcast information distribution system that employs the subject invention can be found in pending U.S. patent application Ser. No. 09/183,249 filed Oct. 30, 1998 and is herein incorporated by reference. That reference discloses a broadcast television environment, such as an ATSC or DTV television environment. However, this does not preclude other types of systems from employing the subject invention. For example, a mobile data wireless transmission system (i.e., a cellular telephone communication system) may also use the modified frame structure. Such a system would not necessarily contain all of the components described in the reference, but would have sufficient equipment to achieve its intended purpose.

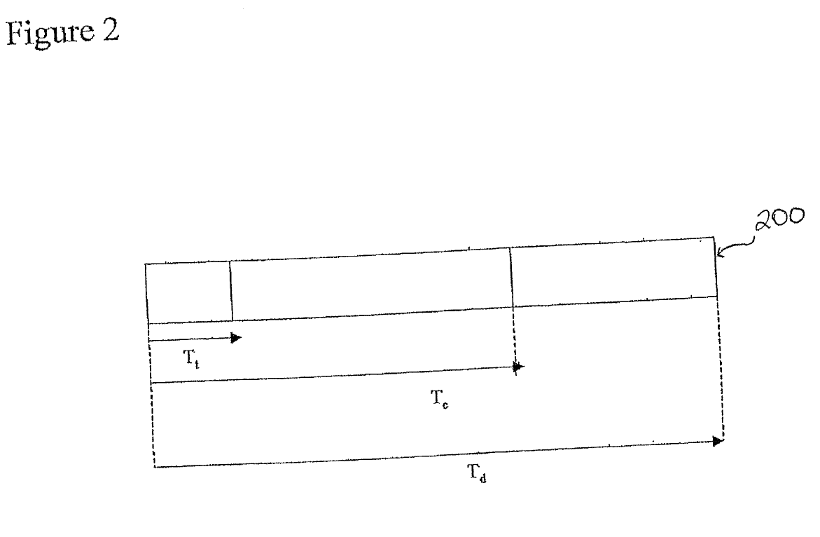

Careful review of the ATSC standard and the field test results point to a distinct possibility that the current 8-VSB modulation scheme can function adequately, provided that the field frame structure is modified. Other modulation schemes stand to benefit as well. Therefore, a modified ATSC frame structure 200 is shown in FIG. 2 and highlights the training signal parameters related to the proposed change. Tₜ identifies the amount of time available to the training function. It reflects the length of the field synchronization sequence. T_{c} identifies the time period for which the equalization filter derived from the training sequence will optimally perform (the convergence period of the equalization filter and training algorithm). T_{d} identifies that period of time for which the derived equalization filter does not adequately perform, because the dynamic multipath has changed significantly (the divergence period). Optimal lengths of the training function and the data field are determined using realistic dynamic multipath simulations. The resulting modifications to the frame are necessary in order to deal more effectively with heavy urban dynamic multipath. The modifications described here are designed to minimize the required changes to current hardware, are readily implemented, and in general, preserve all other aspects of the ATSC standard.

The modified frame structure identifies a set of additional modes for the typical ATSC digital television frame structure. A given transmitter can select from one of these modes to optimize the values Tₜ and T_{c} for the given multipath environment. The modified frame structure is partially backward compatible with the current standard, since the first ‘mode’ of operation defaults to the existing frame structure. In essence, the number of data segments between the field synchronization segments (explained in greater detail below) are varied.

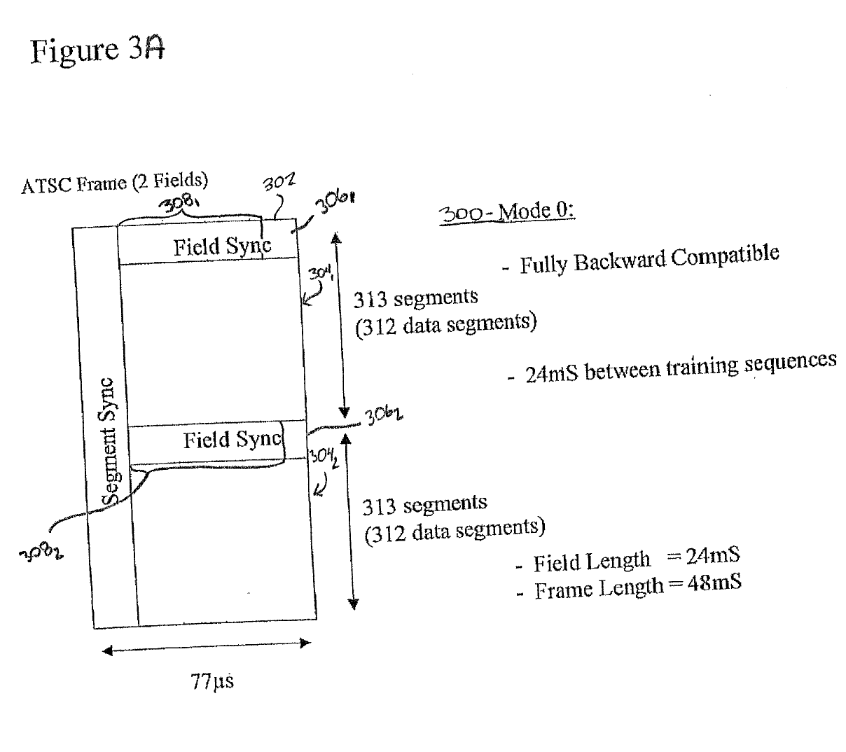

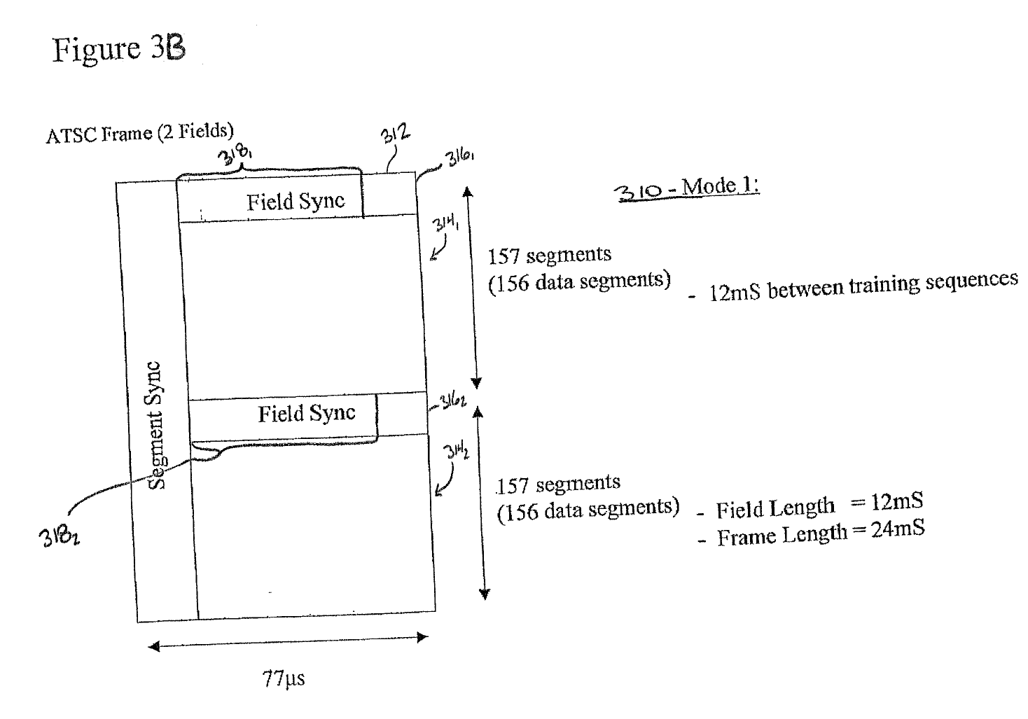

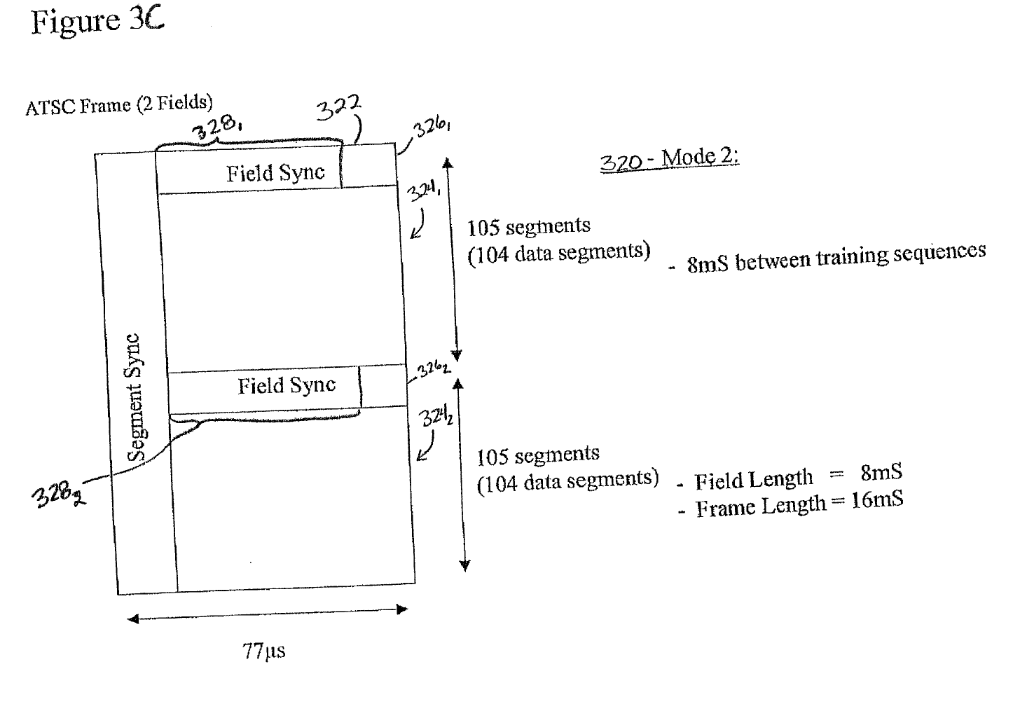

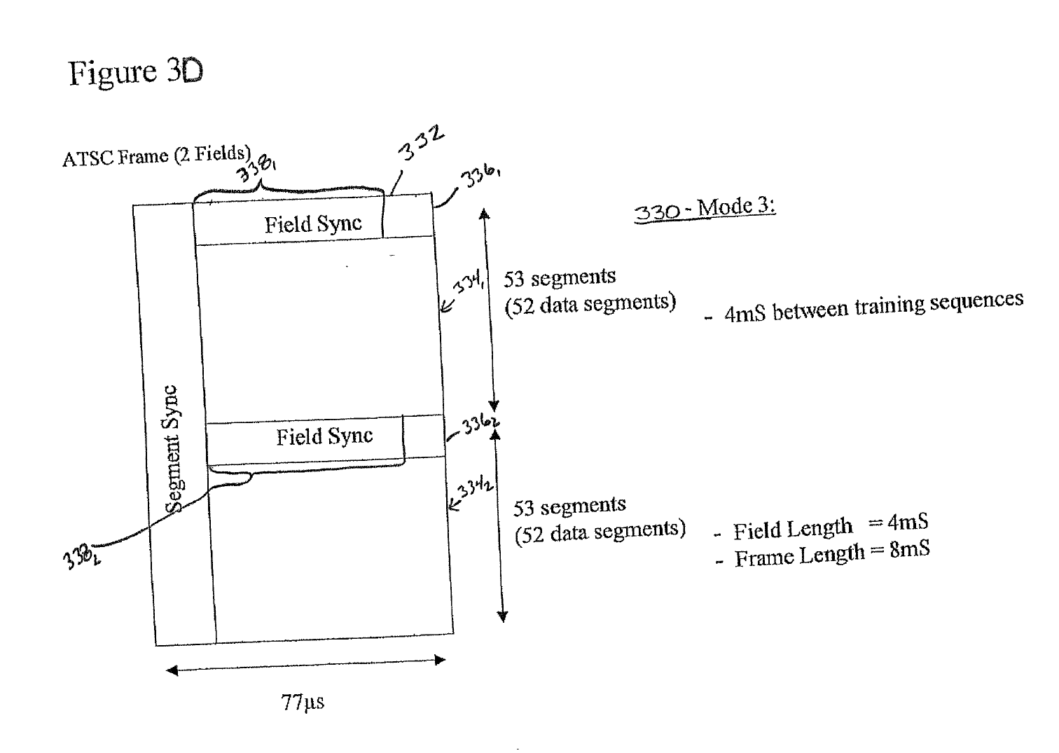

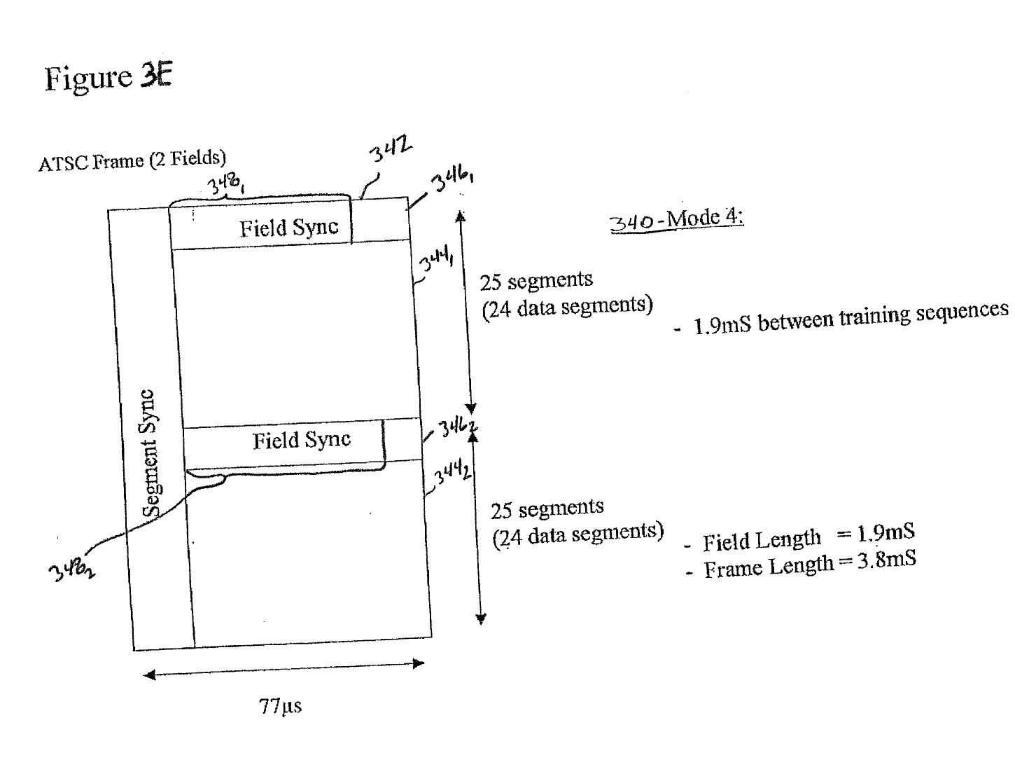

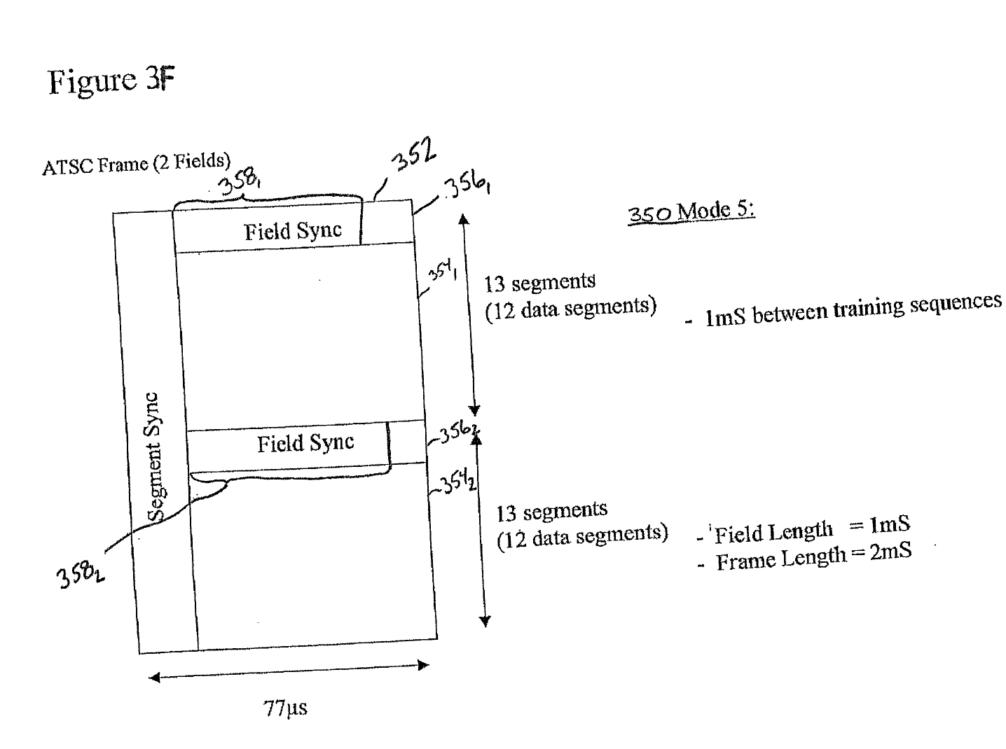

FIG. 3 identifies a plurality of modes (300, 310, 320, 330, 340 and 350) for the modified frame structures. Mode 0 (300) is the current frame structure. Modes 1 through 5 (310 through 350 respectively) provide more frequent training sequences for more severe dynamic multipath environment(s). Table 1 highlights the critical parameters of the modes illustrated in FIG. 3. The first four columns identify the parameter characteristics as defined in FIG. 3. The last two columns (Tₜ and T_{c}) refer to FIG. 2.

Each of the modes (300-350 respectively) will be discussed in detail to identify the specific changes to the frame structure. The existing ATSC frame standard identified as mode 0 (300) has been discussed above, but is defined here for sake of clarity. Specifically, FIG. 3A depicts the standard frame structure 302 comprising two fields 304₁, and 304₂. Each field has a corresponding field synchronization sequence 306₁, 306₂ a portion 308₁, 308₂ of which carries training sequence information. Each field comprises 313 data segments (1 field synchronization sequence segment followed by 312 data segments). Since each segment is 77 microseconds in length, 313×77 microseconds=24 milliseconds between each of the training sequence portions and the total frame length is 48 milliseconds. Such timing between training sequences is deemed adequate under the current standard and in environments where dynamic multipath effects are not a substantial source of image degradation.

FIG. 3B depicts a second mode, mode 1 (310) that is practiced by the subject invention. Specifically, a first modified frame structure 312 is divided into two fields 314₁, 314₂. Each of said fields has a field synchronization segment 316₁ and 316₂ respectively. Each of said field synchronization segments has training segment portions 318₁ and 318₂ respectively. However, a total of 157 segments exist in each field (1 field synchronization segment followed by 156 data segments). Accordingly, 157×77 microseconds=12 milliseconds between training sequence portions. As such, the total frame length equals 24 milliseconds. Since the length of time of the frame is reduced by 50%, the likelihood of entering the divergence time T_{d} is also reduced.

FIG. 3C depicts a third mode, mode 2 (320) of the subject invention. Specifically, a second modified frame structure 322 comprises two fields 324₁ and 234₂ each having one field synchronization segment 326₁ and 326₂. Each of said field synchronization segments further comprises a training sequence portion 328₁. and 328₂. Each field contains 105 segments (1 field synchronization segment followed by 104 data segments). Accordingly 105×77 microseconds=8 milliseconds between training sequence portions. As such, the field length has been reduced to 8 milliseconds and the corresponding frame length has been reduced to 16 milliseconds. It is observed that as the different modes are disclosed, there is a decreasing number of data segments and therefore decreasing field and frame lengths. Such decrease in times further reduces the likelihood of the overall frame falling into the divergence time T_{d}.

FIG. 3D depicts a fourth mode, mode 3 (330) of the specific invention. Specifically, a third modified frame structure 332 comprises two fields 334 and 334₂. Each field comprises a field synchronization segment 336₁ and 336₂. Each field synchronization segment further comprises a training sequence portion 338₁ and 338₂. Each field comprises 53 segments (1 field synchronization segment followed by 52 data segments). Accordingly, 53×77 microseconds=4 milliseconds between each training sequence portion. Accordingly, the overall field length is 4 milliseconds and the frame length is 8 milliseconds.

FIG. 3E depicts a fifth mode, mode 4 (340) of the subject invention. Specifically, a fourth modified frame structure 342 comprises two fields 344₁, and 344₂ Each field further comprises a field synchronization segment 346₁ and 346₂. Each field synchronization segment further comprises a training sequence portion 348₁ and 348₂. Each field further comprises 25 segments (1 field synchronization segment followed by 24 data segments). Accordingly, 25×77 microseconds=1.9 milliseconds between training sequence portions. Accordingly the overall field length equals 1.9 milliseconds and the corresponding frame length is 3,8 milliseconds,

FIG. 3F depicts a sixth mode, mode 5 (350) of the subject invention. A fifth modified frame structure 352 comprises 2 fields 354₁ and 354₂. Each field further comprises a field synchronization portion 356₁ and 356₂. Each field synchronization segment further comprises a training sequence portion 358₁ and 358₂. Each field further comprises 13 segments (1 field synchronization segment followed by 12 data segments). Accordingly, 13×77 microseconds=1 millisecond between training sequence portions. As such, the field length equals 1 millisecond and the frame length equals 2 milliseconds.

TABLE 1

| | Fields per | | Field | | | | |
|---|---|---|---|---|---|---|---|
| Mode | Frame | Segments per Field | Length | | Tₜ | T_{c} | |
| 0 | 2 | 313 (312 data, 1 field sync) | 24 | mS | 77 uS | 24 | mS |
| 1 | 2 | 157 (156 data, 1 field sync) | 12 | mS | 77 uS | 12 | mS |
| 2 | 2 | 105 (104 data, 1 field sync) | 8 | mS | 77 uS | 8 | mS |
| 3 | 2 | 53 (52 data, 1 field sync) | 4 | mS | 77 uS | 4 | mS |
| 4 | 2 | 25 (24 data, 1 field sync) | 1.9 | mS | 77 uS | 1.9 | mS |
| 5 | 2 | 13 (12 data, 1 field sync) | 1 | mS | 77 uS | 1 | mS |

Incorporation of the modified ATSC digital television frame structure requires some additional guidelines for implementation of the data interleaving and channel coding characteristics of the frame structure. The following guidelines are provided for each mode for the following modulation functions: data randomization, Reed-Solomon encoding, data interleaving, Trellis encoding, and nature of the field synchronization segment PN sequences. It should be noted that the modified frame structure, specifically the repetition of a training signal more frequently within the frame structure, does not preclude other optimization of the training sequence itself (including lengthening the sequence or changing it in some other way) or other changes to the modulation functions. Similarly, the specifically shown shortened data segments disclosed in Table 1 and in the following Modes should not be considered limiting to the invention. Other types of shortened segment formats (i.e., different number of data segments) are equally able to achieve the desired results.

Mode 0:

Same as current ATSC terrestrial broadcast mode.

Segments per field: 313 (312 data, 1 field synchronization)

Time b/n training sequences: 24 mS

Mode 1:

Segments per field: 157 (156 data, 1 field synchronization)

Time b/n training sequences: 12 mS

Data Randomizer operates as in current ATSC standard, and is re-initialized every field. Reed-Solomon encoding operates as in current ATSC standard (block convolution on a segment-by-segment case). Interleaving operates as in current ATSC standard (4 mS deep interleaving, synchronized to the first data byte of a field). Trellis encoding operates as in current ATSC standard. Field synchronization segment contains same PN sequences as in current ATSC standard.

Mode 2:

Segments per field: 105 (104 data, 1 field synchronization)

Time b/n training sequences: 8 mS

Data Randomizer operates as in current ATSC standard, and is re-initialized every field. Reed-Solomon encoding operates as in current ATSC standard (block convolution on a segment-by-segment case). Interleaving operates as in current ATSC standard (4 mS deep interleaving, synchronized to the first data byte of a field). Field synchronization segment contains same PN sequences as in current ATSC standard. In general the same Trellis coding algorithm is used, but minor modifications may be desired.

Mode 3:

Segments per field: 53 (52 data, 1 field synchronization)

Time b/n training sequences: 4 mS

Data Randomizer operates as in current ATSC standard, and is re-intialized every field. Reed-Solomon encoding operates as in current ATSC standard (block convolution on a segment-by-segment case). In general, the same interleaving algorithm is used as in the current ATSC standard (4 mS deep interleaving). However, synchronization may not be conducted every field. In general, the same Trellis coding algorithm is used but minor modifications may be desired Field synchronization segment contains same PN sequences as in current ATSC standard.

Mode 4:

Segments per field: 25 (24 data, 1 field synchronization)

Time b/n training sequences: 1.9 mS

Data randomizer operates as in current ATSC standard, and is re-initialized every field. Reed-Solomon encoding operates as in current ATSC standard (block convolution on a segment-by-segment case). In general, the same interleaving algorithm is used as in the current ATSC standard (4 mS deep interleaving). However, synchronization may not be conducted every field. Trellis encoding operates as in current ATSC standard. Field synchronization segment contains same PN sequences as in current ATSC standard.

Mode 5:

Segments per field: 13 (12 data, 1 field synchronization)

Time b/n training sequences: 1 mS

Data randomizer operates as in current ATSC standard, and is re-initialized every field. Reed-Solomon encoding operates as in current ATSC standard (block convolution on a segment-by-segment case). In general, the same interleaving algorithm is used as in the current ATSC standard (4 mS deep interleaving). However, synchronization may not be conducted every field. Trellis encoding operates as in current ATSC standard. Field synchronization segment contains same PN sequences as in current ATSC standard.

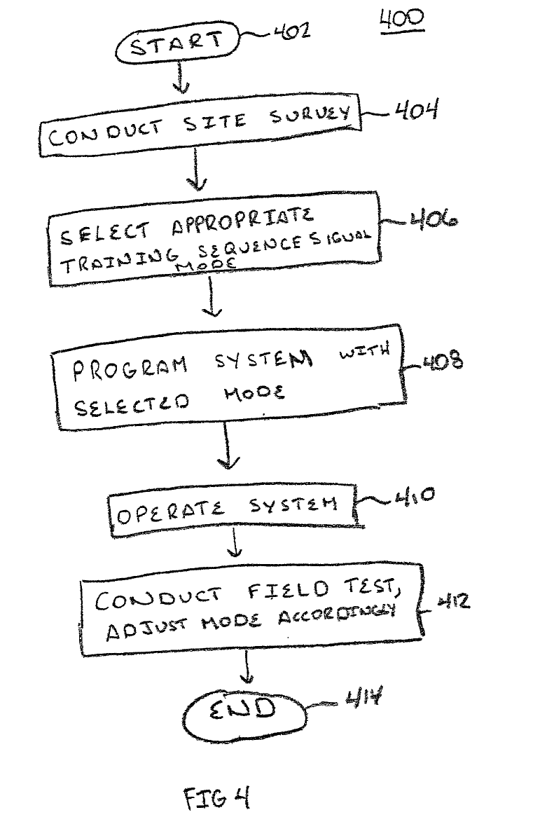

Each of the above-identified broadcasting modes is available as part of a selection system to provide the most advantageous data transferal for a given environment. However, a determination of which mode to select is necessary. FIG. 4 depicts a series of method steps 400 for a first method of selecting the proper mode and implementing it in a broadcast system. Specifically, the method starts at step 402 and proceeds to step 404 where a site survey is conducted. Specifically, the area in which ATSC DTV broadcast signals will be received is surveyed taking into consideration the nature of the multipath environment that such signals will encounter (i.e., number and or density of moving vehicular traffic, number of buildings in the survey area and the likelihood of their movement due to wind conditions and the like). Based on the information collected in the survey, the appropriate training sequence signal mode is selected at step 406. At step 408, the receiver end of the broadcasting system or equipment is programmed with the selected training sequence signal mode using a control signal in the modified frame structure. That is, one mode is selected based upon the expected conditions and the system will be able to compensate for the multipath signal environment based only upon such selected and preprogrammed mode. At step 410, the system is operated so that actual signals are broadcast and received into the survey area. At step 412 a field test is conducted in the survey area to make a determination as to whether the anticipated multipath environment and selected mode were properly matched up. For example, a determination as to whether the training signal mode is adequate can involve measurement of error rates (symbol error rate) or by direct observation of the dynamic nature of the equalization filter coefficients during the field test. If necessary, a new training sequence signal mode can be selected and the system reprogrammed accordingly to account for any variations in the anticipated signal behavior. The method ends at step 414.

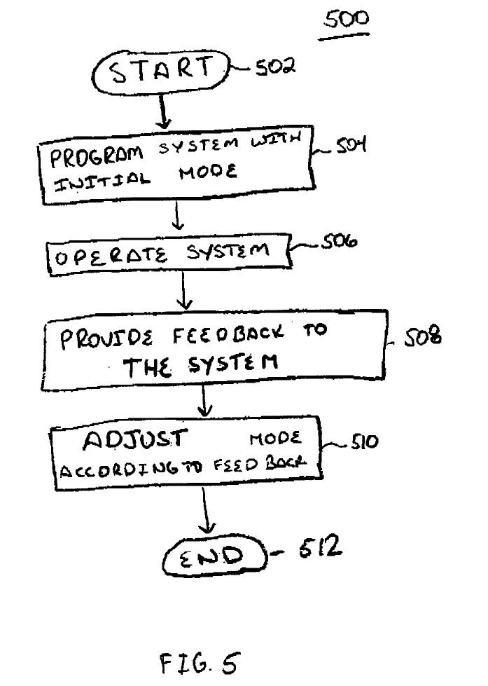

This disclosure may include special applications whereby the frame is dynamically adapted. A second method for implementing the various modes of the specific invention in a broadcast system is depicted in FIG. 5. Specifically, a series of method steps 500 is shown. The method starts at step 502 and proceeds to step 504 wherein the broadcast system is initially programmed with a initial mode value (i.e., mode 0). At step 506 a broadcast system is operated in accordance with normal procedures. At step 508 information regarding received image quality is collected and integrated in to the system. This collection may be by automatically feeding back data from specific receivers in the broadcast system to transmitters or by registering customer complaints or reactions to picture quality when broadcasting in the initial mode. At step 510, the system is adjusted to a different mode if necessary according to the feedback information provided. For example, the system may be automatically self-adjusted to select a higher mode or system operators can instruct the system to operate at a higher mode (i.e., mode 1). The method ends at step 512. An example of the information necessary to be fed back into the system and to effect a mode change is similar to the determinations made in the field test in the first method. For example error rate measurement or automated observation of equalization filter coefficients are monitored and are converted into a feedback signal. Such feedback signal may be provided to the transmitters via a phone connection or other similar communication device. Such automated modality changes, in addition to the operator-adjusted (or “fixed” modes), would allow for real time monitoring of expected hot spots where multipath conditions are considered to be exceptionally challenging.

This subject invention, modified frame structure, and mode selection techniques for the ATSC Digital Television standard does not preclude implementation of some other method of feedback (regarding error rate or dynamic multipath conditions) to the transmitter. Any form of feedback would simply provide information so that the frame structure could be optimized as needed as described in the proposed standard change. As an additional feature to the subject invention, a space is reserved in the frame synchronization segment. This space is allocated to identification of the specific mode of training signal operation is currently in use, so that receivers can automatically adapt to provide correct equalization filter training and signal processing as a function of training mode.

While foregoing is directed to the preferred embodiment of the present invention, other and further embodiments of the invention may be devised without departing from the basic scope thereof, and the scope thereof is determined by the claims that follow.

1. An enhanced frame structure for transmitting and receiving wireless data signals as a plurality of frames, comprising:
an initial frame structure containing at least two fields, each of said fields having a field synchronization segment followed by a plurality of initial frame structure data segments; and
a first or more modified frame structures containing at least two fields, each of said fields having a field synchronization segment followed by at least a plurality of first modified frame structure data segments that is less than the plurality of initial frame structure data segments.

2. The enhanced frame structure of claim 1 comprising a second modified frame structure containing at least two fields, each of said fields having a field synchronization segment followed by a plurality of second modified frame structure data segments that is less than the plurality of the first modified frame structure data segments.

3. The enhanced frame structure of claim 2 further comprising a third modified frame structure containing at least two data fields, each of said data fields having a field synchronization segment followed by a plurality of third modified frame structure data segments that is less than the plurality of the second frame structure data segments.

4. The enhanced frame structure of claim 3 further comprising a fourth modified frame structure containing at least two data fields, each of said data fields having a field synchronization segment followed by a plurality of fourth modified frame structure data segments that is less than the plurality of the third frame structure data segments.

5. The enhanced frame structure of claim 4 further comprising a fifth modified frame structure containing at least two data fields, each of said data fields having a field synchronization segment followed by a plurality of fifth modified frame structure data segments that is less than the plurality of the fourth frame structure data segments.

6. The enhanced frame structure of claim 1 wherein the plurality of first modified frame structure data segments is 156.

7. The enhanced frame structure of claim 2 wherein the plurality of second modified frame structure data segments is 104.

8. The enhanced frame structure of claim 3 wherein the plurality of third modified frame structure data segments is 52.

9. The enhanced frame structure of claim 4 wherein the plurality of fourth modified frame structure data segments is 24.

10. The enhanced frame structure of claim 5 wherein the plurality of fifth modified frame structure data segments is 12.

11. The enhanced frame structure of claim 1 wherein the wireless data signals are digital television signals.

12. A method for utilizing an enhanced frame structure for the broadcast of wireless data signals comprising:
conducting a site survey of the area to receive said signals;
selecting an appropriate training sequence signal mode of the enhanced frame structure selected from the group consisting of a mode for an initial frame structure and a mode for a first or more modified frame structures;
programming a system for broadcasting said signals with said selected training sequence signal mode;
operating said system to broadcast said signals;
conducting a field test; and
adjusting the training sequence signal mode according to the results of the field test.

13. The method of claim 12 wherein the step of selecting an appropriate training sequence signal mode results in a digital television transmission having an enhanced frame structure that comprises at least two fields, each of said fields having a field synchronization segment containing a training sequence signal followed by a plurality of modified frame structure data segments that are less in quantity than a plurality of frame structure data segments of the initial frame structure.

14. The method of claim 13 wherein the plurality of modified frame structure data segments may be selected from the group consisting of 156 data segments, 104 data segments, 52 data segments, 24 data segments, and 12 data segments.

15. The method of claim 12 wherein the wireless data signals are digital television signals.

16. A method for utilizing an enhanced frame structure for the broadcast of wireless data signals comprising:
programming a system to deliver the wireless data signals in an initial transmission mode;
operating said system;
collecting feedback from the system; and
adjusting the initial transmission mode according to said feedback to alter the frame structure to an enhanced frame structure, wherein a plurality of frame structure data segments of the enhanced mode is less than a plurality of frame structure data segments of the initial transmission mode.

17. The method of claim 16 wherein the wireless data signals are digital television signals.

18. The method of claim 16 wherein the mode can be selected to enhance the frame structure data segment plurality to a number selected from a group consisting of 156 data segments, 104 data segments, 52 data segments, 24 data segments, and 12 data segments.

19. The method of claim 16 wherein the adjusting step is performed by selecting an option from the group consisting of by the system self-adjusting to automatic feedback and manually by system operators selecting a new mode.
